(19) United States
(12) Patent Application Publication
(10) Pub. No.: US 2026/0358743 A1
(43) Pub. Date: Nov. 12, 2026

(54) SHEET CONVEYANCE APPARATUS, SHEET CONVEYANCE SYSTEM, AND IMAGE FORMING SYSTEM

(71) Applicant: CANON KABUSHIKI KAISHA, Tokyo (JP)

(72) Inventors: SHO MATSUI, Chiba (JP); HIROSHIGE INOUE, Tokyo (JP)

(21) Appl. No.: 19/640,592

(22) Filed: Apr. 7, 2026

(30) Foreign Application Priority Data
May 8, 2025 (JP) 2025-078139

(51) Int. Cl. G03G 15/00; G03G 21/16

(52) U.S. Cl. CPC G03G 15/6567; G03G 15/6511; G03G 21/1619; G03G 2215/00565; G03G 2215/00721; G03G 2215/00759

(57) ABSTRACT

A sheet conveyance apparatus includes an apparatus body frame, a conveyance unit configured to convey a sheet, a movement mechanism configured to move the conveyance unit in a width direction orthogonal to a sheet conveyance direction, a movement drive unit configured to drive the movement mechanism, a guide portion configured to guide the sheet conveyed by the conveyance unit toward an outside of the sheet conveyance apparatus, and a support frame configured to support the conveyance unit, the movement mechanism, the movement drive unit, and the guide portion. The support frame is configured to be pivotably supported with respect to the apparatus body frame.

### BACKGROUND

### Field of the Technology

This disclosure relates to a sheet conveyance apparatus that conveys a sheet, a sheet conveyance system, and an image forming system.

### Description of Related Art

In image forming apparatuses, in order to correct a lateral deviation of a sheet in a width direction, an apparatus is proposed in which a position of the sheet in the width direction is detected by a contact image sensor (CIS), and, based on this detection, a registration roller pair is shifted in the width direction of the sheet (refer to Japanese Patent Laid-Open No. 2014-107515).

### SUMMARY

According to a first aspect of the present disclosure, a sheet conveyance apparatus includes an apparatus body frame, a conveyance unit configured to convey a sheet, a movement mechanism configured to move the conveyance unit in a width direction orthogonal to a sheet conveyance direction, a movement drive unit configured to drive the movement mechanism, a guide portion configured to guide the sheet conveyed by the conveyance unit toward an outside of the sheet conveyance apparatus, and a support frame configured to support the conveyance unit, the movement mechanism, the movement drive unit, and the guide portion. The support frame is configured to be pivotably supported with respect to the apparatus body frame.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system according to this embodiment.

FIG. 2 is a schematic diagram illustrating a registration unit and a sheet discharge unit according to this embodiment.

FIG. 3 is a perspective view illustrating the sheet discharge unit, each drive motor, and each transmission belt according to this embodiment.

FIG. 4 is a side view illustrating the sheet discharge unit, each drive motor, and each transmission belt according to this embodiment.

FIG. 5 is a perspective view illustrating a conveyance support frame supported by an apparatus body frame according to this embodiment.

FIG. 6 is a perspective view illustrating a shift drive structure of a sheet discharge roller pair according to this embodiment.

FIG. 7 is a side view illustrating a state in which a shift roller unit according to this embodiment is viewed from downstream in a sheet conveyance direction.

FIG. 8 is a perspective view illustrating a separation drive structure of the sheet discharge roller pair according to this embodiment.

FIG. 9A is a perspective view illustrating a separation mechanism according to this embodiment in a state in which the sheet discharge roller pair is brought into pressure contact.

FIG. 9B is a perspective view illustrating the separation mechanism according to this embodiment in a state in which the sheet discharge roller pair is separated.

FIG. 10A is a side view illustrating a state in which a rear side pivot shaft according to this embodiment is mounted to the apparatus body frame and the conveyance support frame.

FIG. 10B is a side view illustrating a state in which the rear side pivot shaft according to this embodiment is withdrawn from the apparatus body frame and the conveyance support frame.

FIG. 11 is a perspective view illustrating a conveyance drive structure of the sheet discharge roller pair according to this embodiment.

### DESCRIPTION OF THE EMBODIMENTS

In image forming systems configured by connecting a plurality of apparatuses, sheet discharge units that guide a sheet to sheet discharge ports are configured to pivot so as to bring the height of the sheet discharge ports in upstream apparatuses in alignment with sheet receiving ports of downstream apparatuses. However, when such a sheet discharge unit, which is configured to pivot, and a unit disclosed in Japanese Patent Laid-Open No. 2014-107515, which shifts a width direction of the sheet are arranged in sequence in a sheet conveyance direction, such arrangement leads to an increase in the size of the apparatus. Therefore, the development of a sheet conveyance apparatus that can be reduced in size is desired. Hereinafter, embodiments according to this disclosure will be described with reference to drawings.

### Image Forming System

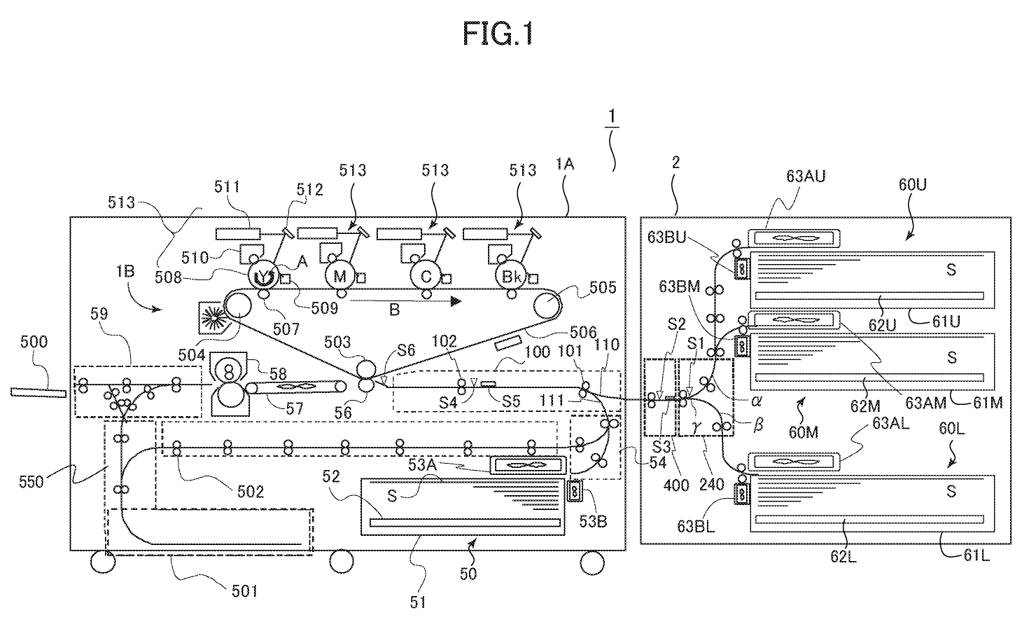

First, an overall configuration of an image forming system 1 according to this embodiment will be described. FIG. 1 is a schematic diagram illustrating the image forming system according to this embodiment. The image forming system 1, which is also a sheet conveyance system, is provided with an image forming apparatus 1A and a sheet feeding apparatus 2 connected to the image forming apparatus 1A. To be noted, the image forming apparatus 1A can also be referred to as a downstream apparatus disposed downstream of the sheet feeding apparatus 2 in a sheet conveyance direction.

The image forming system 1 forms an image on a sheet S using an image forming unit 1B while conveying the sheets S one sheet at a time. As the sheet, which is a recording material (recording medium), various sheet materials having different sizes and materials can be used, including paper such as plain paper and thick paper, sheet materials subjected to surface treatment such as coated paper, sheet materials having special shapes such as envelopes and index paper, plastic films, cloth, and the like.

The image forming apparatus 1A includes the image forming unit 1B of a tandem-type intermediate transfer system in which four process units 513 are arranged along an intermediate transfer belt 506, serving as an intermediate transfer member. Since, as compared with a direct transfer system, it is not necessary to retain the sheet S on a transfer drum or a transfer belt, the intermediate transfer system has an advantage of being easily adaptable to various types of the sheet S such as extra-thick paper and coated paper. In addition, the tandem-type intermediate transfer system is suited for achieving high productivity due to its characteristics of parallel processing in the plurality of process units 513 and collective transfer of a full-color image formed by superimposing toner images of a plurality of colors.

To be noted, the image forming unit 1B is an example of an image forming unit that forms the image on the sheet S, and an electrophotographic unit of the direct transfer system may be used in which a toner image formed on a photosensitive drum 508 is transferred onto the sheet S without interposing the intermediate transfer member. In addition, the image forming unit is not limited to electrophotographic systems, and may be, for example, an inkjet type print unit.

Each process unit 513 includes the photosensitive drum 508, serving as an image bearing member, a charge unit, an exposing unit 511, a developing unit 510, and a cleaning unit 509. The intermediate transfer belt 506 is stretched around a drive roller 504, a tension roller 505, and a secondary transfer inner roller 503, and the intermediate transfer belt 506 is driven for conveyance in a direction B indicated by an arrow in FIG. 1. On an inner circumferential side of the intermediate transfer belt 506, primary transfer rollers 507 are disposed at positions corresponding to each photosensitive drum 508. In addition, on an outer circumferential side of the intermediate transfer belt 506, a secondary transfer roller 56 is disposed at a position opposing the secondary transfer inner roller 503 across the intermediate transfer belt 506.

In addition, the image forming apparatus 1A includes a sheet feeding unit 50, a pre-registration conveyance unit 54, and a registration unit 100. Further, the image forming apparatus 1A includes a pre-fixing conveyance unit 57, a fixing unit 58, a branch conveyance portion 59, a reverse discharge portion 550, a duplex reverse portion 501, and a duplex conveyance portion 502.

The flow of an image forming operation will be described. Here, the sheet S is assumed to be fed from the sheet feeding unit 50 within an apparatus body.

The sheet feeding unit 50 includes a storage chamber 51, which is a so-called cassette, and a lift plate 52 that supports the sheet. Further, the sheet feeding unit 50 is configured to include an air separating unit 53B that blows air onto the sheet supported on the lift plate 52 to separate the sheet, and an air feeding unit 53A that feeds the separated sheet by air suction. The sheet S in the storage chamber 51 is stored in a stacked state on the lift plate 52, and is raised and lowered by a lift-up device (not shown). The sheet S in the storage chamber 51 is separated by the air separating unit 53B blowing strong air onto an end portion on an upstream side in the sheet conveyance direction; thereby, upper several sheets are adapted to be separated, and the sheet S is fed one sheet at a time by the air feeding unit 53A in synchronization with the operation timing of the image forming unit 1B. To be noted, sheet feeding methods include air suction methods in which the sheet S is attracted to belts by negative pressure generated by fans and conveyed, and roller methods that utilize the frictional force of rollers that rotate in contact with the sheet S. The air feeding unit 53A in FIG. 1 employs the air suction method. The sheet S fed by the air feeding unit 53A passes through the pre-registration conveyance unit 54, and is conveyed from a conveyance path 111 to the registration unit 100.

The registration unit 100 is provided with a second pre-registration sensor S4 that detects a leading edge of the sheet S, and a second lateral registration sensor S5 that detects an edge portion in a width direction (hereinafter referred to as "side edge") of the sheet S. Further, the registration unit 100 is provided with a registration roller pair 102. The second lateral registration sensor S5 is constituted by a contact image sensor or the like, and detects a position of the side edge of the sheet S by an image that has been detected. The rotation of the registration roller pair 102 is stopped after a preceding sheet S has passed through, and the leading edge of the sheet S is brought into contact with the registration roller pair 102; thereby, the sheet S is caused to be deflected and the leading edge is caused to follow the registration roller pair 102 to correct skew. Then, based on the timing at which the leading edge of the sheet S is detected by the second pre-registration sensor S4, the registration roller pair 102 starts rotation at timing at which a predetermined amount of deflection has been formed in the sheet S, and conveys the sheet S. In addition, the registration roller pair 102 is configured to move (shift) in the width direction by a shift mechanism and a shift motor, not shown, and, in a state of nipping the sheet S, performs lateral deviation registration correction of a position in the width direction of the sheet S based on a detection result of the second lateral registration sensor S5.

A pre-registration sensor S6 that detects the leading edge of the sheet S is disposed downstream of the registration unit 100 in the sheet conveyance direction. The registration roller pair 102 measures a delay time of the sheet S with respect to a reference conveyance timing based on the detection result of the pre-registration sensor S6, and, accordingly, a conveyance speed of the sheet S is controlled so as to cancel the delay time. After the skew correction and the lateral deviation registration correction are performed in the registration unit 100, the sheet S is fed to a secondary transfer portion. The secondary transfer portion is a nip portion formed between the secondary transfer roller 56 and the intermediate transfer belt 506.

In parallel with the conveyance operation of the sheet S to the secondary transfer portion described above, the toner image is formed in the image forming unit 1B. The photosensitive drum 508 and the intermediate transfer belt 506 are rotatably driven in predetermined directions A and B. In each process unit 513, a surface of the photosensitive drum 508 is charged by the charge unit. The exposing unit 511 performs exposure of the photosensitive drum 508 based on image information and writes an electrostatic latent image on the surface of the photosensitive drum 508. The developing unit 510 supplies toner as developer to the photosensitive drum 508, and develops the electrostatic latent image into a monochrome toner image of yellow, magenta, cyan, or black. These monochrome toner images are primarily transferred from the photosensitive drums 508 onto the intermediate transfer belt 506 by the primary transfer rollers 507. At this time, the four-color monochrome toner images overlap each other on the intermediate transfer belt 506; thereby the full-color image is formed on the intermediate transfer belt 506. Residual toner remaining on the photosensitive drum 508 that was not transferred onto the intermediate transfer belt 506 is removed by the cleaning unit 509.

The full-color image is conveyed to the secondary transfer portion by the rotation of the intermediate transfer belt 506. Then, in the secondary transfer portion, the toner image is transferred from the intermediate transfer belt 506 onto the sheet S by applying voltage to the secondary transfer roller 56.

The sheet S that has passed through the secondary transfer portion is conveyed to the fixing unit 58 by the pre-fixing conveyance unit 57. The fixing unit 58, for example, while nipping and conveying the sheet S by a roller pair, heats the image on the sheet S using heat generated by a heat source, such as a halogen lamp, to fix the image onto the sheet S. By the branch conveyance portion 59, the sheet S that has passed through the fixing unit 58 is either discharged directly toward a sheet discharge tray 500 or guided to the reverse discharge portion 550. By the reverse discharge portion 550, the image forming apparatus 1A can discharge the sheet S onto the sheet discharge tray 500 in a state in which the surface on which the image was transferred in the secondary transfer portion is reversed to face downward (face-down).

To be noted, in a case of duplex printing in which the images are formed on both sides of sheet S, the sheet S on which the image has been formed on a first surface thereof is conveyed from the branch conveyance portion 59 to the duplex reversing portion 501 through the reverse discharge portion 550. Then, the sheet S that has been switchbacked in the duplex reversing portion 501 is conveyed again to pre-registration conveyance unit 54 via the duplex conveyance portion 502. Thereafter, after the image is formed on a second surface in the same manner as the first surface, the sheet S is discharged to the sheet discharge tray 500.

To be noted, the sheet fed from the sheet feeding apparatus 2 described below is conveyed to the registration unit 100 via a merging conveyance path 110 through which the sheet from the sheet feeding apparatus 2 is merged. A subsequent operation after the pre-registration conveyance unit 54 is the same as in a case where the sheet S is fed from the storage chamber 51.

### Sheet Feeding Apparatus

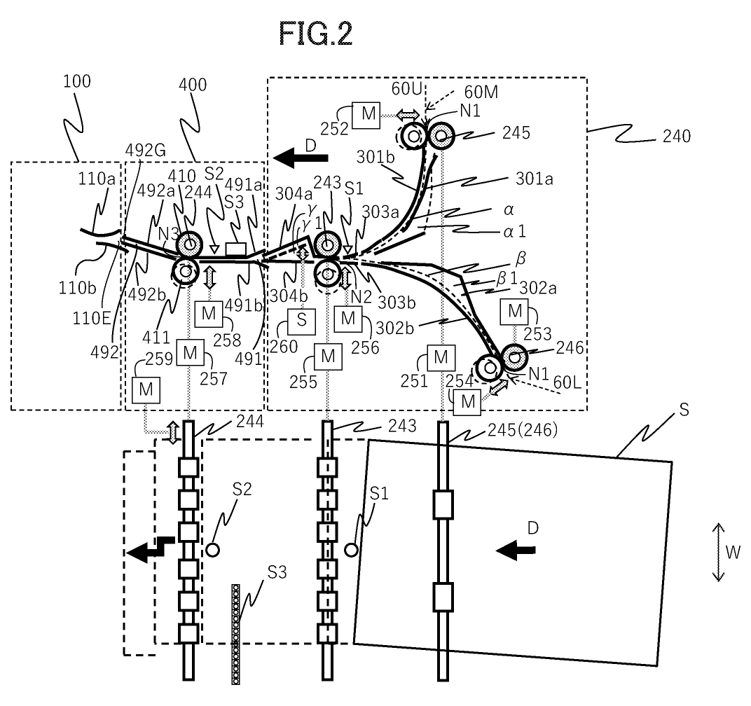

Next, the sheet feeding apparatus 2, serving as a sheet conveyance apparatus according to this embodiment, will be described. In this embodiment, the sheet feeding apparatus 2 feeds the sheet S toward the image forming apparatus 1A. As illustrated in FIG. 1, the sheet feeding apparatus 2 according to this embodiment includes sheet feeding units 60U, 60M, and 60L, serving as three-stage feeding units arranged vertically. In addition, the sheet feeding apparatus 2 includes a registration unit 240 for performing the skew correction of the sheet S. Further, the sheet feeding apparatus 2 is provided with a discharge unit 400, serving as a conveyance unit, including a discharge path 492 (refer to FIG. 2), serving as a discharge guide portion or a guide portion that performs the lateral registration correction of the sheet S and discharges the sheet to the image forming apparatus 1A.

Each of the sheet feeding units 60U, 60M, and 60L includes a configuration similar to the sheet feeding unit 50 within the apparatus body. That is, each of the sheet feeding units 60U, 60M, and 60L includes a storage chambers 61U, 61M, or 61L, which is a so-called cassette, and a lift plate 62U, 62M, or 62L that supports the sheet. In addition, each of the sheet feeding units 60U, 60M, and 60L includes an air separating unit 63BU, 63BM, or 63BL that blows air onto the sheet supported by the lift plate 62U, 62M, or 62L to separate the sheet. Then, each of the sheet feeding units 60U, 60M, and 60L includes an air feeding unit 63AU, 63AM, or 63AL that feeds the sheet separated by air through air suction. The sheet S in the storage chambers 61U, 61M, and 61L is stored in a stacked state on the lift plates 62U, 62M, and 62L, and is raised and lowered by a lift-up device (not shown). The sheet S in the storage chambers 61U, 61M, and 61L is separated by the air separating unit 63BU, 63BM, or 63BL, which blows strong air onto an upstream end portion in the sheet conveying direction; thereby, several upper sheets are adapted to be separated. Then, the separated sheet S is fed one sheet at a time by the air feeding unit 63AU, 63AM, or 63AL.

The sheet S fed from the upper and middle sheet feeding units 60U and 60M is conveyed through an upper conveyance path α, which is a sheet conveyance path. The sheet fed from the lower sheet feeding unit 60L is conveyed through a lower conveyance path β, which is a sheet conveyance path. The upper and lower conveyance paths α and β merge at the registration unit 240 to form a horizontal path γ, which is a sheet conveyance path. The horizontal path γ extends in a substantially horizontal direction, communicates with a conveyance path 491 (refer to FIG. 2) of the discharge unit 400, and communicates with the merging conveyance path 110 of the image forming apparatus 1A via the discharge path 492 (refer to FIG. 2). Therefore, the sheet S fed from each of the sheet feeding units 60U, 60M, and 60L is conveyed to the image forming apparatus 1A via the registration unit 240 and the discharge unit 400.

Similarly to the sheet feeding unit 50 of the image forming apparatus 1A, in the image forming operation, the sheet S is fed from any one of the sheet feeding units 60U, 60M, and 60L in synchronization with the operation timing of the image forming unit 1B. A pre-shift sensor S2, serving as a first detection unit, that detects the leading edge of the sheet S is disposed in the discharge unit 400. A control unit of the image forming apparatus 1A temporarily stops a discharge roller pair 244 based on the detection of the leading edge of the sheet by the pre-shift sensor S2, and causes the sheet S to abut against a nip portion N3 and deflect. Thereafter, based on the detection timing of the leading edge of the sheet by the pre-shift sensor S2, the discharge roller pair 244 is driven in synchronization with the operation timing of the image forming unit 1B, and resumes the conveyance of the sheet S. Thereby, the sheet S can be fed to the image forming apparatus 1A in a state in which variations in conveyance timing that occurred inside the sheet feeding apparatus 2 are adjusted while correcting the skew of the sheet.

### Schematic Configuration of Registration Unit and Discharge Unit

Next, a schematic configuration of the registration unit 240 and the discharge unit 400 according to this embodiment will be described. FIG. 2 is a schematic diagram illustrating the registration unit and the discharge unit according to this embodiment. To be noted, as illustrated in FIG. 2, a direction in which the sheet is conveyed in the registration unit 240 and the discharge unit 400 is referred to as a sheet conveyance direction D, and a direction that is orthogonal to the sheet conveyance direction and also is a width direction of the sheets is referred to as a width direction W. In addition, the width direction W is a front-rear direction of the sheet feeding apparatus 2 or the image forming apparatus 1A, and in this specification, the front is also referred to as a front side and the rear is also referred to as a rear side. In addition, generally, the front in the sheet feeding apparatus 2 or the image forming apparatus 1A is a direction toward which an operation panel (not shown) is directed.

As illustrated in FIG. 2, the registration unit 240 includes a registration roller pair, an upper conveyance roller pair 245, and a lower conveyance roller pair 246. The discharge unit 400 includes the discharge roller pair 244. To be noted, as described in detail below, also the discharge roller pair 244 is configured to perform skew correction. Therefore, the registration roller pair 243 can be considered as a first registration roller pair, and the discharge roller pair 244 can be considered as a second registration roller pair disposed downstream of the first registration roller pair.

The registration roller pair 243 and the discharge roller pair 244 are disposed in the horizontal path γ. In the sheet conveyance direction D in the horizontal path γ, the discharge roller pair 244 is positioned downstream of the registration roller pair 243.

The upper conveyance roller pair 245 is disposed in the upper conveyance path α, and is positioned upstream of the registration roller pair 243 in the sheet conveyance direction D in the upper conveyance path α. The lower conveyance roller pair 246 is disposed in the lower conveyance path β, and is positioned upstream of the registration roller pair 243 in the sheet conveyance direction D in the lower conveyance path β.

The upper conveyance roller pair 245 is constituted by a drive roller that is rotatably driven by a driving force of a conveyance motor 251 (M in FIG. 2 indicates a motor), and a driven roller that forms a nip portion N1 together with the drive roller and rotates by following the drive roller. In addition, the upper conveyance roller pair 245 is configured such that the drive roller and the driven roller can be brought into contact with and separated from each other (can open and close the nip portion N1) by a driving force of a separation motor 252.

In addition, similarly, the lower conveyance roller pair 246 is constituted by a drive roller that is rotatably driven by a driving force of a conveyance motor 253, and a driven roller that forms a nip portion N4 together with the drive roller and rotates by following the drive roller. In addition, the lower conveyance roller pair 246 is configured such that the drive roller and the driven roller can be brought into contact with and separated from each other (can open and close the nip portion N4) by a driving force of a separation motor 254.

In addition, similarly, the registration roller pair 243 is constituted by a drive roller that is rotatably driven by a driving force of a conveyance motor 255, and a driven roller that forms a nip portion N2 together with the drive roller and rotates by following the drive roller. In addition, the registration roller pair 243 is configured such that the drive roller and the driven roller can be brought into contact with and separated from each other (can open and close the nip portion N2) by a driving force of a separation motor 256.

Then, similarly, the discharge roller pair 244 is constituted by a drive roller that is rotatably driven by a driving force of a conveyance motor 257, and a driven roller that forms the nip portion N3 together with the drive roller and rotates by following the drive roller. In addition, the discharge roller pair 244 is configured such that the drive roller and the driven roller can be brought into contact with and separated from each other (can open and close the nip portion N3) by a driving force of a separation motor 258.

Accordingly, in this embodiment, the rotary drive of each roller pair (243, 244, 245, 246) is configured to be controlled independently. In addition, each roller pair (243, 244, 245, 246) is configured such that the drive and driven rollers are independently controlled to be brought into contact with or separated from each other (opening/closing of the nip portions).

Further, the discharge roller pair 244 is configured to shift in the sheet width direction by a driving force of a shift motor 259. The sheet width direction is a direction parallel to a rotational axis of the discharge roller pair 244. The shift motor 259 functions as a movement drive unit for the lateral deviation registration correction, which moves the discharge roller pair 244 in the sheet width direction based on a detection result of a first lateral registration sensor S3 to correct a positional deviation in the width direction.

Between the upper conveyance roller pair 245 and the registration roller pair 243, the upper conveyance path α is formed by an upper guide 301a and a lower guide 301b. Between the upper conveyance roller pair 245 and the registration roller pair 243, the upper conveyance path α is curved such that the lower guide 301b is positioned on an outer side of a curvature and the upper guide 301a is positioned on an inner side of the curvature. The upper guide 301a is a swing guide urged by a spring (not shown), and is configured such that, when a loop is formed by the sheet S, the guide pivots so as to curve in an outward direction, and, thereby, forms a space α1 that permits the formation of the loop which is formed when the sheet abuts against the nip portion of the registration roller pair 243. Thereby, for example, in a thick-paper mode in which a type of the sheet to be supplied is thick paper, skew correction can be performed in a state in which the sheet S is significantly curved along the curved upper conveyance path α. As a result, the possibility of defective skew correction due to leading edge penetration at the registration roller pair 243 or due to the slippage of the lower conveyance roller pair 245 is more reliably reduced.

Between the lower conveyance roller pair 246 and the registration roller pair 243, the lower conveyance path β is formed by an upper guide 302a and a lower guide 302b. The lower conveyance path β is curved between the lower conveyance roller pair 246 and the registration roller pair 243 such that the lower guide 302b is positioned on an inner side of a curvature and the upper guide 302a is positioned on an outer side of the curvature. A distance between the lower guide 302b (inner guide) and the upper guide 302a (outer guide) is wider at an intermediate portion between the lower conveyance roller pair 246 and the registration roller pair 243 than at portions adjacent to the lower conveyance roller pair 246 and the registration roller pair 243. Therefore, a space β1, which permits the sheet S to deflect (form a loop) toward the outer side of the curvature of the lower conveyance path β, is formed at the intermediate portion between the lower conveyance roller pair 246 and the registration roller pair 243. Accordingly, similarly, for example, in the thick paper mode, skew correction can be performed in a state in which the sheet S is significantly curved along the curved lower conveyance path β. As a result, the possibility of defective skew correction due to the leading edge penetration at the registration roller pair 243 or due to the slippage of the lower conveyance roller pair 246 is more reliably reduced.

The upper and lower conveyance paths α and β merge at a portion adjacent to an upstream side of the registration roller pair 243. A conveyance path on a downstream side of the merging portion of the upper and lower conveyance paths α and β is formed by an upper guide 303a and a lower guide 303b.

The horizontal path γ is formed by an upper guide 304a and a lower guide 304b between the registration roller pair 243 and the discharge roller pair 244. In the horizontal path γ, a portion of the upper guide 304a is recessed upward. In other words, the upper guide 304a includes a recess portion recessed such that a portion of the upper guide 304a in the sheet conveyance direction D moves away (retracts from) the lower guide 304b. Thereby, a space γ1, which permits the sheet S to deflect toward an upward direction (form a loop), is formed between the registration roller pair 243 and the discharge roller pair 244. That is, for example, in a thin paper mode in which a type of the sheet to be supplied is thin paper, the space γ1 for receiving a loop L of the sheet S is provided in an upper portion of the horizontal path γ. Since thin paper (particularly, ultra-thin paper) has low rigidity, if the space γ1 for receiving the loop L were provided in a lower portion of the horizontal path γ, the sheet S would deflect toward the space γ1 before loop formation; therefore, there is the possibility of causing defective skew correction. According to the configuration of this embodiment, such inconvenience can be avoided.

To be noted, the lower guide 304b serves as a flapper guide, and the lower guide 304b retracts toward a side of the upper guide 304a via a solenoid 260 and a link mechanism (not shown); thereby, multi-fed sheets or a jammed sheet can be discharged toward a downward direction from the horizontal path γ.

The registration unit 240 includes a first pre-registration sensor S1, and the discharge unit 400 includes a pre-shift sensor S2, serving as a first detection unit, and the first lateral registration sensor S3, serving as a second detection unit, which is an image reading sensor that performs the image detection of the side edge of the sheet. The first pre-registration sensor S1 is disposed in an area adjacent to the upstream side of the registration roller pair 243. The pre-shift sensor S2 and the first lateral registration sensor S3 are disposed in areas adjacent to an upstream side of the discharge roller pair 244.

The first pre-registration sensor S1 and the pre-shift sensor S2 are used to obtain passage timings of the leading edge and trailing edge of the sheet S for controlling a sheet conveyance operation. The first pre-registration sensor S1 is used for conveyance control including, for example, the control of a deflection amount (loop amount) when abutting the leading edge of the sheet S against the nip portion N2 of the registration roller pair 243 to correct skew. The pre-shift sensor S2 is used for conveyance control including, for example, the control of a deflection amount (loop amount) when abutting the leading edge of the sheet S against the nip portion N3 of the discharge roller pair 244 to correct skew.

The first lateral registration sensor S3 is, for example, a contact image sensor (CIS) type line sensor including light-receiving elements arranged in the sheet width direction. The first lateral registration sensor S3 is capable of obtaining information on the position of the side edge of the sheet S in the sheet width direction. The first lateral registration sensor S3 is used for the alignment (lateral registration) of the image formed by the image forming unit 1B with respect to the sheet S in the sheet width direction (main scanning direction). In this embodiment, the lateral deviation registration correction (lateral registration) is performed by shifting the discharge roller pair 244 in the sheet width direction based on the detection result of the first lateral registration sensor S3 in a state in which the discharge roller pair 244 is nipping the sheet S.

The sheet S that has undergone the lateral deviation registration correction as described above is conveyed through the discharge path 492 formed by the upper and lower guides 492a and 492b, is discharged from a discharge port 492G of the discharge path 492, and is delivered to the merging conveyance path 110 of the image forming apparatus 1A. The merging conveyance path 110 is formed by an upper guide 110a and a lower guide 110b, and the upper and lower guides 110a and 110b are formed such that a receiving port 110E, which is an upstream end in the sheet conveyance direction D, is formed to be wider than the discharge port 492G of the discharge path 492. To be noted, since a position of the receiving port 110E of the image forming apparatus 1A is determined, as described in detail below, it becomes necessary to align a position of the discharge port 492G in the vertical direction by pivoting the discharge path 492 in the vertical direction.

### Issues in Image Forming System

In recent years, due to demands for storing a plurality of types of media and large volumes of sheets, by connecting a plurality of sheet feeding apparatuses in tandem in sheet conveyance directions, or by connecting a plurality of other processing apparatuses, overall systems increase in size, and conveyance paths become longer; thereby, sheets become more likely to cause positional deviations in width directions. In addition, when sheet feeding methods employ air feeding configurations using air suction methods or air separation methods as in this embodiment, the positional deviations of the sheets tend to become greater than those in, for example, roller-based feeding methods. If an attempt is made to correct such large positional deviations of the sheets in the width directions in a single operation, a residual positional deviation may occur, and deterioration in the quality of deliverables may result.

In addition, in sheet feeding apparatuses such as that of this embodiment, since sheets are fed from a plurality of sheet feeding units, merging portions at which conveyance paths merge are necessary. Further, downstream in the sheet conveyance directions of the merging portions, escape flapper portions for discharging multi-fed or jammed sheets and loop spaces for correcting skew are sometimes provided. In order to correct the positional deviations of sheets in the width directions, so as to ensure the conveyance of the sheets to downstream apparatuses, it is necessary to dispose sensors for detecting the positional deviations and roller pairs capable of moving the sheets in the width directions at positions downstream of the escape flapper portions or the loop spaces, which are the positions at which the conveyance of the sheets is assured.

In addition, discharge paths for discharging sheets are required to be pivotably disposed so as to reliably deliver the sheets having high rigidity to subsequent apparatuses.

However, when units that perform the lateral deviation registration correction of the sheets, and units that are pivotably configured to discharge the sheets are arranged in sequence along the sheet conveyance directions as described above, there is an issue that the sheet conveyance apparatuses may become large in size. In particular, in image forming systems which are required to connect a plurality of sheet feeding apparatuses, the overall systems may become large in size. Therefore, in this embodiment, these issues are resolved by adopting the configuration described below.

### Overall Configuration of Discharge Unit

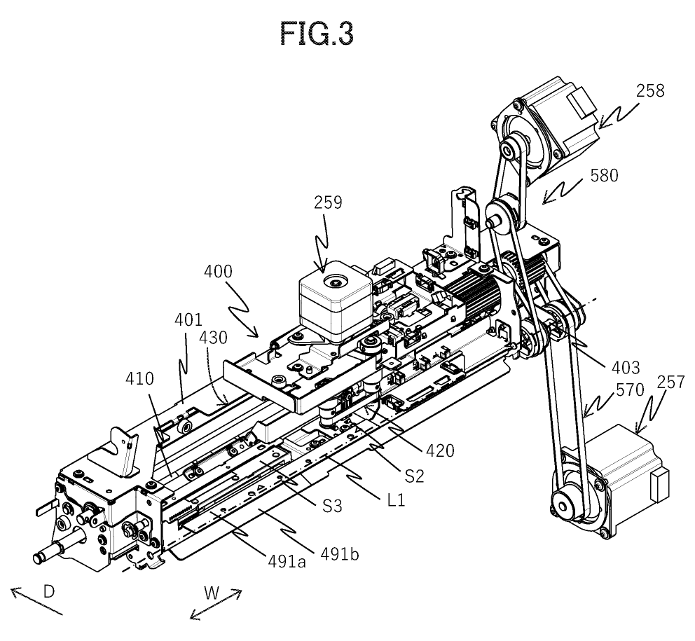

Next, using FIGS. 2 and 3, an overall configuration of the discharge unit 400 according to this embodiment will be described. FIG. 3 is a perspective view illustrating the discharge unit, each drive motor, and each transmission belt according to this embodiment, that is, a diagram illustrating the discharge unit 400, drive sources connected to the discharge unit 400, and drive transmission paths thereof.

As illustrated in FIG. 2, the discharge roller pair 244 described above is disposed between conveyance path 491 and the discharge path 492, which constitute a conveyance path of the discharge unit 400. The discharge roller pair 244 forms the nip portion N3 with a discharge drive roller 410, serving as a drive roller, and a discharge driven roller 411, serving as a driven roller; thereby, the discharge roller pair 244 nips and conveys the sheet S downstream in the sheet conveyance direction D. As illustrated in FIG. 3, the discharge drive roller 410 is rotated when drive rotation, which is output from the conveyance motor 257, serving as a conveyance drive unit, is transmitted via a conveyance transmission portion 570, which is constituted by a belt and a pulley, described in detail below; thereby, the discharge drive roller 410 conveys the sheet S in the sheet conveyance direction D.

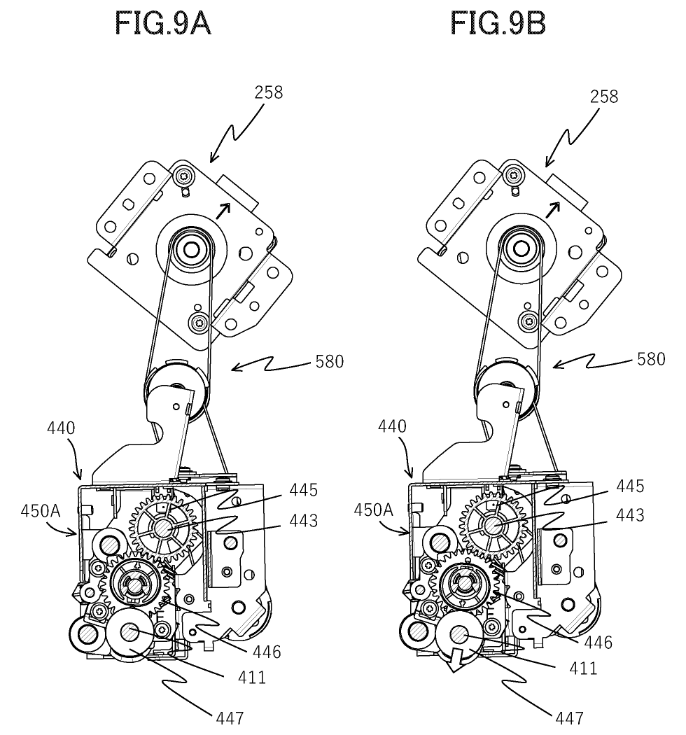

In addition, it is possible to open the nip portion N3 by separating the discharge driven roller 411 from the discharge drive roller 410. That is, when drive rotation from the separation motor 258 is transmitted via a separation transmission portion 580 constituted by a belt and a pulley, described in detail below, and a separation mechanism 440 (refer to FIGS. 9A to 9B) is driven, the discharge driven roller 411 is separated from the discharge drive roller 410.

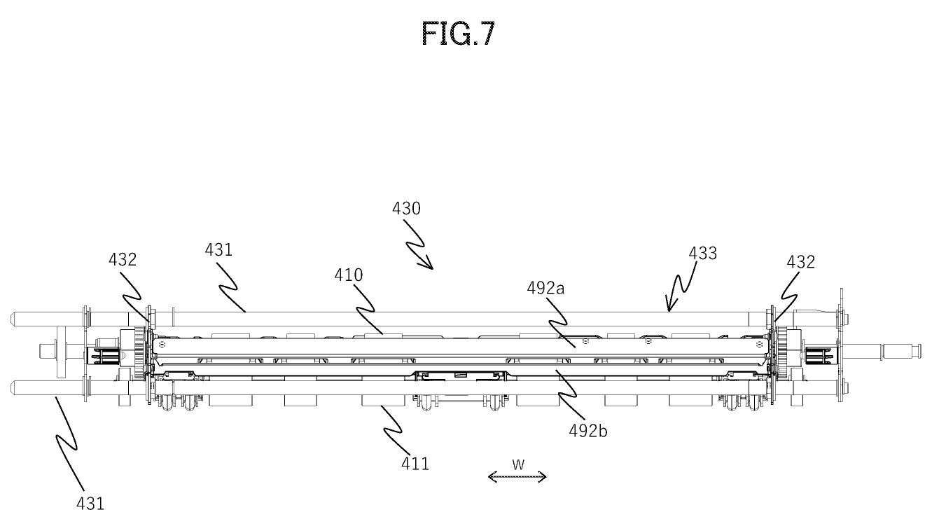

Further, the discharge roller pair 244 is supported by a shift roller unit 430 (refer to FIG. 7), serving as a conveyance unit, and when moving the shift roller unit 430, the discharge roller pair 244 is movable so as to shift in the width direction W (axial direction of roller) orthogonal to the sheet conveyance direction D. That is, drive rotation from the shift motor 259, serving as a movement drive unit, is transmitted to a shift drive unit 420, serving as a movement mechanism, and the shift roller unit 430 is moved by the shift drive unit 420 so as to shift in the width direction W.

Around the discharge unit 400 that operates as described above, the conveyance motor 257 and the conveyance transmission portion 570, and the separation motor 258, serving as a separation drive unit, and the separation transmission portion 580 are disposed. Then, the discharge unit 400 includes a support frame 401, and, in a form of being supported by the support frame 401, the shift motor 259, the shift drive unit 420, and the shift roller unit 430 including the discharge roller pair 244 are provided. In addition, the discharge unit 400 is provided with, in a form of being supported by the support frame 401, the separation mechanism 440.

In addition, as illustrated in FIGS. 2 and 3, upstream of the discharge roller pair 244 in the sheet conveyance direction D, the discharge unit 400 is provided with an upper guide 491a and a lower guide 491b that form the conveyance path 491 in a form of being supported by the support frame 401. Further, the pre-shift sensor S2 that detects the sheet S, and the first lateral registration sensor S3 that detects the positional information of an end portion of the sheet S in a roller axial direction are disposed in the upper guide 491a. The lower guide 491b, serving as an opposing guide, is disposed opposite to the first lateral registration sensor S3, and, thereby, forms the conveyance path 491 in which a reading position of the first lateral registration sensor S3 is disposed. In addition, downstream of the discharge roller pair 244 in the sheet conveyance direction D, the discharge unit 400 is provided with an upper guide 492a and a lower guide 492b that form the discharge path 492 for delivering the sheet to the merging conveyance path 110 of the registration unit 100 of the image forming apparatus 1A. Accordingly, the discharge unit 400 is provided with, in a form of being supported by the support frame 401, the upper and lower guides 491a and 491b, the pre-shift sensor S2, the first lateral registration sensor S3, and the upper and lower guides 492a and 492b.

As described above, the discharge unit 400 supporting the respective constituting components on the support frame 401 is pivotably supported with respect to an apparatus body frame 201 provided in the sheet feeding apparatus 2. Hereinafter, a structure for pivotably supporting the discharge unit 400 will be described, and a shift drive structure, a separation drive structure, and a conveyance drive structure will be respectively described in detail according to each function provided in the discharge unit 400.

### Pivotable Supporting Configuration of Discharge Unit

To reliably deliver a high-rigidity sheet from the sheet feeding apparatus 2 to the image forming apparatus 1A, it is desirable that the curvature of the connecting conveyance path (particularly between the horizontal path γ and the conveyance path 491, and between the discharge path 492 and the merging conveyance path 110) is gradual. In a case where the curvature of the conveyance path is sharp, when conveying the high-rigidity sheet, conveyance resistance may increase; therefore, there is a concern that motor step-out due to insufficient torque in a conveyance motor for sheet conveyance may be led, and a conveyance failure may result. In addition, there is a concern that slippage may occur between the sheet and the roller pair, and a roller slip mark may be formed on the sheet thereby deteriorating the quality of deliverables.

In this embodiment, to resolve such issues, the support frame 401 of the discharge unit 400 is pivotably supported by the apparatus body frame 201 of the sheet feeding apparatus 2, and a support angle of the discharge unit 400 is configured to be adjusted. Thereby, configuring the conveyance path having a gradual curvature is achieved for the conveyance paths extending from the horizontal path γ of the registration unit 240 to the conveyance path 491 of the discharge unit 400, and from the discharge path 492 to the merging conveyance path 110 of the registration unit 100.

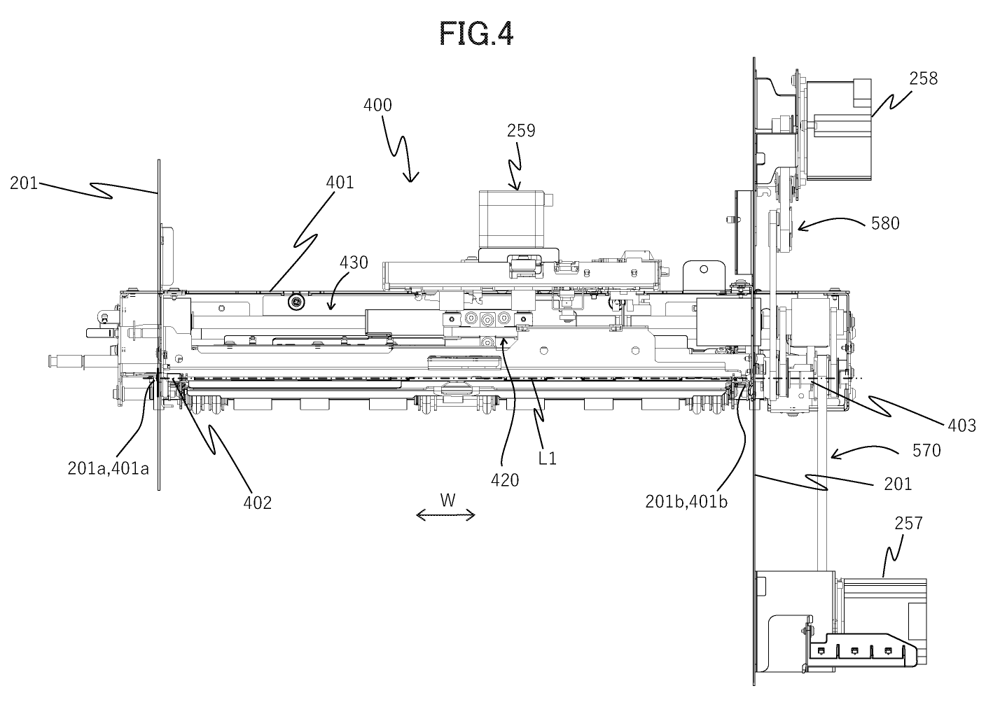

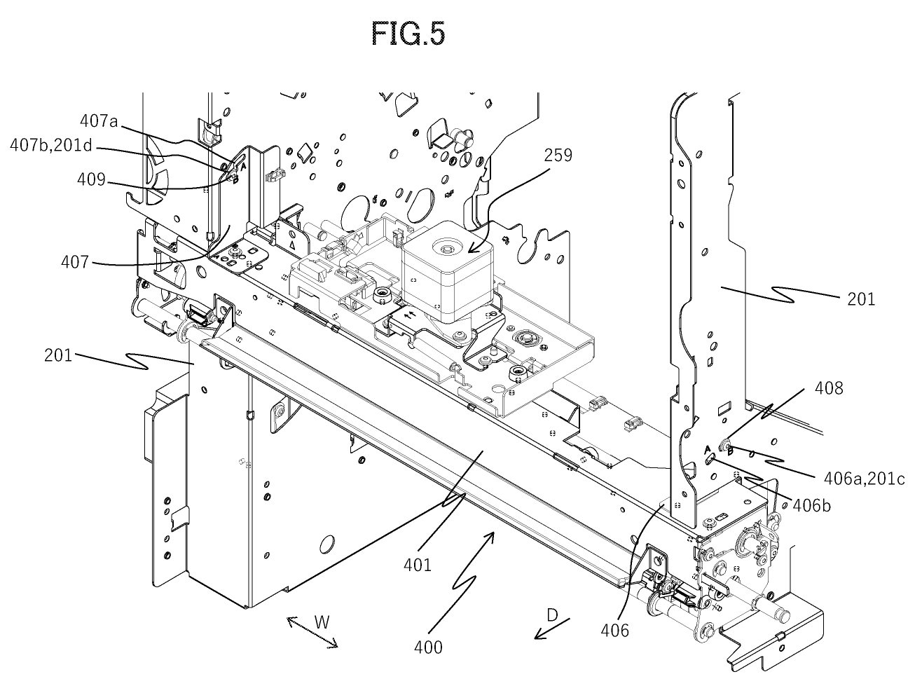

Here, the structure for pivotably supporting the support frame 401 of the discharge unit 400 with respect to the apparatus body frame 201 of the sheet feeding apparatus 2 will be described in detail using FIGS. 4 and 5. FIG. 4 is a side view illustrating a state in which the discharge unit, each drive motor, and each transmission belt according to this embodiment are viewed from upstream in the sheet conveyance direction. FIG. 5 is a perspective view illustrating a state in which the conveyance support frame supported by the apparatus body frame according to this embodiment is viewed from downstream in the sheet conveyance direction.

As illustrated in FIG. 4, in the support frame 401 of the discharge unit 400, a through hole 401a and a through hole 401b are respectively formed at a first end on one side (front side) and at a second end on the other side (rear side) in the width direction W. In addition, also in the apparatus body frame 201 of the sheet feeding apparatus 2, a through hole 201a and a through hole 201b are respectively formed at a first end on the one side (front side) and at a second end on the other side (rear side) in the width direction W. These through holes 401a and 201a, and the through holes 401b and 201b are disposed on the same straight line L1. Then, a front side pivot shaft 402, serving as a support shaft, is inserted into the through holes 401a and 201a, and a rear side pivot shaft 403, serving as a support shaft, is inserted into the through holes 401b and 201b. Thereby, the discharge unit 400 (the support frame 401 thereof) is pivotably supported with respect to the apparatus body frame 201, using the front and rear side pivot shafts 402 and 403 as fulcrums.

In this embodiment, the centers of the through holes 401a and 201a and the through holes 401b and 201b, that is, the axial centers of the front and rear side pivot shafts 402 and 403, are disposed adjacent to an upstream end portion in the sheet conveying direction D of the conveyance path 491. By disposing the pivot fulcrums in this manner, a downstream end portion of the horizontal path γ and the upstream end portion of the conveyance path 491 become substantially coincident in position regardless of a pivot angle of the discharge unit 400. Thereby, the sheet delivery between the registration unit 240 and the discharge unit 400 can be performed smoothly.

In addition, as illustrated in FIG. 5, brackets 406 and 407 are fixed to an upper portion of the support frame 401 of the discharge unit 400 adjacent to both ends in the width direction W. The bracket 406 is formed with pivot range restriction holes 406a and 406b that are formed in an elongated hole shape along an arc centered on axes of the front and rear side pivot shafts 402 and 403, and penetrate through the bracket 406. Similarly, the bracket 407 is formed with pivot range restriction holes 407a and 407b that are formed in an elongated hole shape along the arc centered on the axes of the front and rear side pivot shafts 402 and 403, and penetrate through the bracket 407. In addition, a screw hole 201c is formed in the apparatus body frame 201 at a position that enables alignment with the pivot range restriction holes 406a and 406b in the width direction W. Further, similarly, a screw hole 201d is formed in the apparatus body frame 201 at a position that enables alignment with the pivot range restriction holes 407a and 407b in the width direction W.

Then, by screwing a screw 408 into the screw hole 201c through the pivot range restricting hole 406a or 406b, and screwing a screw 409 into the screw hole 201d through the pivot range restricting hole 407a or 407b, the discharge unit 400 can be positioned and secured to the apparatus body frame 201. Then, positions at which the screws 408 and 409 are fastened to the pivot range restricting hole 406a or 406b and the pivot range restricting hole 407a or 407b are selected. Thereby, an angle of the discharge unit 400, in which the front and rear side pivot shafts 402 and 403 serve as fulcrums, can be selected with respect to the apparatus body frame 201; that is, the discharge unit 400 can be selectively set at two positions, roughly an upward position and a downward position.

### Configuration for Determining Pivot Position of Discharge Unit

Next, a configuration for determining a pivot position (angle) of the discharge unit 400 such that, in a case where the image forming apparatus 1A and the sheet feeding apparatus 2 are connected, the discharge path 492 and the merging conveyance path 110 form an appropriate angle will be described.

Prior to connecting the image forming apparatus 1A and the sheet feeding apparatus 2, the discharge unit 400 is positioned using a range of adjustment tolerances of the pivot range restriction holes 406a and 406b and the pivot range restriction holes 407a and 407b such that the upper and lower guides 492a and 492b are oriented vertically upward. Then, in this state, the discharge unit 400 is provisionally secured using the screws 408 and 409. Thereby, in the case of connecting the image forming apparatus 1A and the sheet feeding apparatus 2, contact between the upper and lower guides 492a and 492b of the discharge path 492 and the upper and lower guides 110a and 110b of the merging conveyance path 110 is prevented.

Next, when loosening the screws 408 and 409, the discharge unit 400 pivots under its own weight, and, thereby, the lower guide 492b of the discharge path 492 comes into contact with the lower guide 110b of merging conveyance path 110, and the discharge unit 400 is brought into a state in which pivotal movement is restricted. Then, thereafter, the discharge unit 400 is secured to the apparatus body frame 201 using the screws 408 and 409. In this manner, the conveyance path for delivering the sheet from the discharge path 492 of the discharge unit 400 to the merging conveyance path 110 of the image forming apparatus 1A obtains an appropriate cross-sectional configuration having a graduate curvature when viewed from the width direction W; thereby, it becomes possible to stably and accurately convey even the sheet having high rigidity.

In addition, as described above, the pivot range restriction holes 406a and 406b and the pivot range restriction holes 407a and 407b are configured to permit the discharge unit 400 to pivot to different angles, that is, are configured such that the discharge path 492 can correspond to different discharge angles. With this configuration, the sheet feeding apparatus 2 can be connected even to image forming apparatuses in which the height of the merging conveyance path 110 differs.

### Shift Drive Structure of Discharge Roller Pair

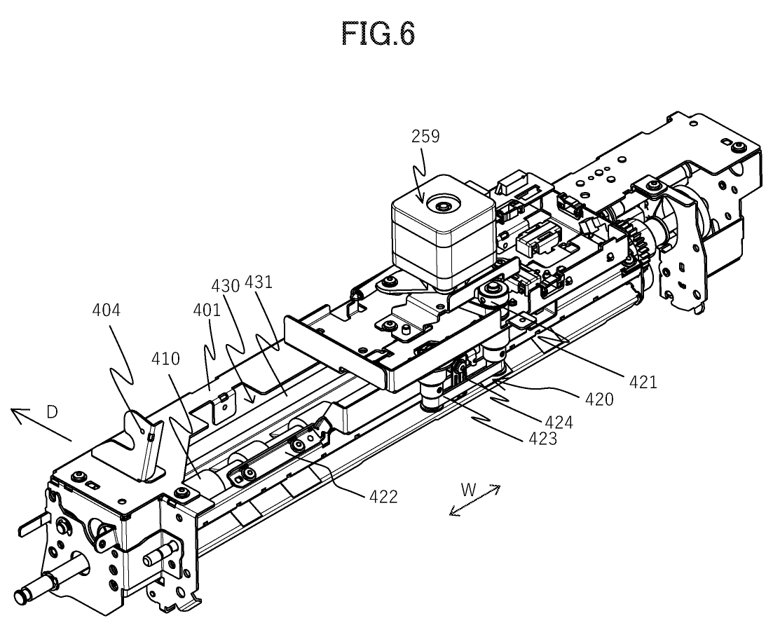

Next, the shift drive structure for shifting (moving) the discharge roller pair 244 in the width direction W in the discharge unit 400 will be described using FIGS. 6 and 7. FIG. 6 is a perspective view illustrating the shift drive structure of the discharge roller pair according to this embodiment. FIG. 7 is a side view illustrating a state in which the shift roller unit according to this embodiment is viewed from downstream in the sheet conveyance direction.

As illustrated in FIG. 6, the discharge unit 400 includes the support frame 401 described above, and the support frame 401 supports the shift motor 259, the shift drive unit 420, and the shift roller unit 430.

In the shift roller unit 430, as illustrated in FIG. 7, two shift shafts 431 are connected by a plurality of connecting members 432 to constitute a frame body 433, serving as a conveyance frame. In addition, in the shift roller unit 430, the discharge drive and driven rollers 410 and 411 are rotatably supported with respect to the frame body 433. The frame body 433 of the shift roller unit 430 is supported so as to be movable in the width direction W with respect to the support frame 401. Therefore, the discharge roller pair 244, constituted by the discharge drive and driven rollers 410 and 411, is configured to move in the width direction W by shift-driving the integrated shift roller unit 430 in the width direction W. To be noted, the upper and lower guides 492a and 492b, which form the discharge path 492, are also secured to the connecting members 432, and these upper and lower guides 492a and 492b are also shift-driven in the width direction W as a portion of the shift roller unit 430.

On the other hand, as illustrated in FIG. 6, the shift motor 259 is secured to the support frame 401, and the drive rotation which is output from the shift motor 259 is transmitted to the shift drive unit 420. The shift drive unit 420 includes a shift drive train 421 and a shift transmission belt 423. In addition, the shift drive unit 420 includes a registration shift connecting plate 422 fixedly connected to the shift roller unit 430 described above, and a belt stopper 424 secured to the registration shift connecting plate 422 and the shift transmission belt 423.

When the drive rotation from the shift motor 259 is transmitted to the shift drive train 421 by a belt and the like (illustration omitted), the shift transmission belt 423, which is wound around the shift drive train 421, rotates. Then, when the shift transmission belt 423 is rotated, the registration shift connecting plate 422 is moved in the width direction W via the belt stopper 424 connected thereto, and the shift roller unit 430 described above is moved toward one side in the width direction W. In addition, by reversing a direction of the drive rotation of the shift motor 259, the shift roller unit 430 is moved toward the other side in the width direction. As described above, the shift roller unit 430 is configured to be shift-driven in the width direction W (axial direction of roller) with respect to the discharge unit 400.

### Separation Drive Structure of Discharge Driven Roller

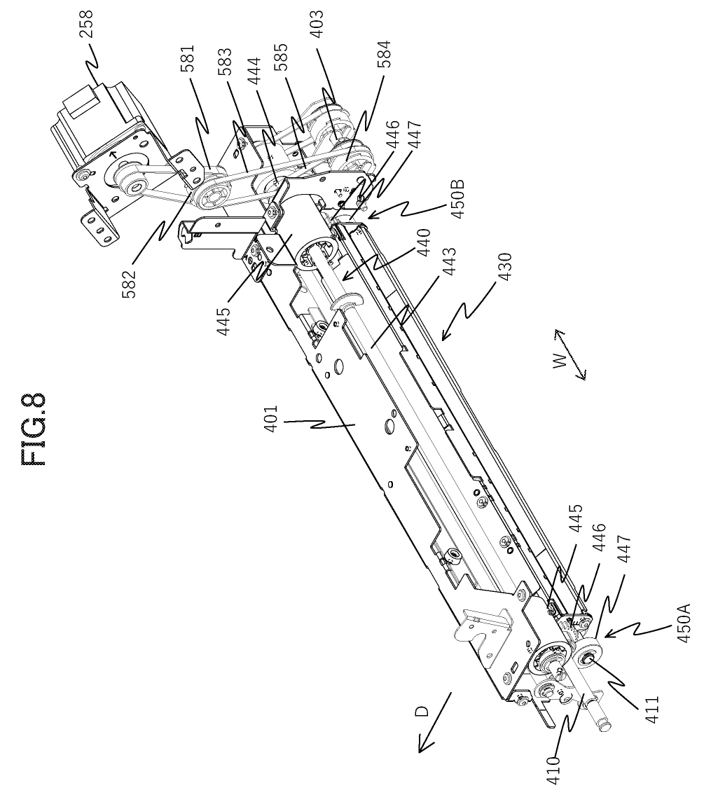

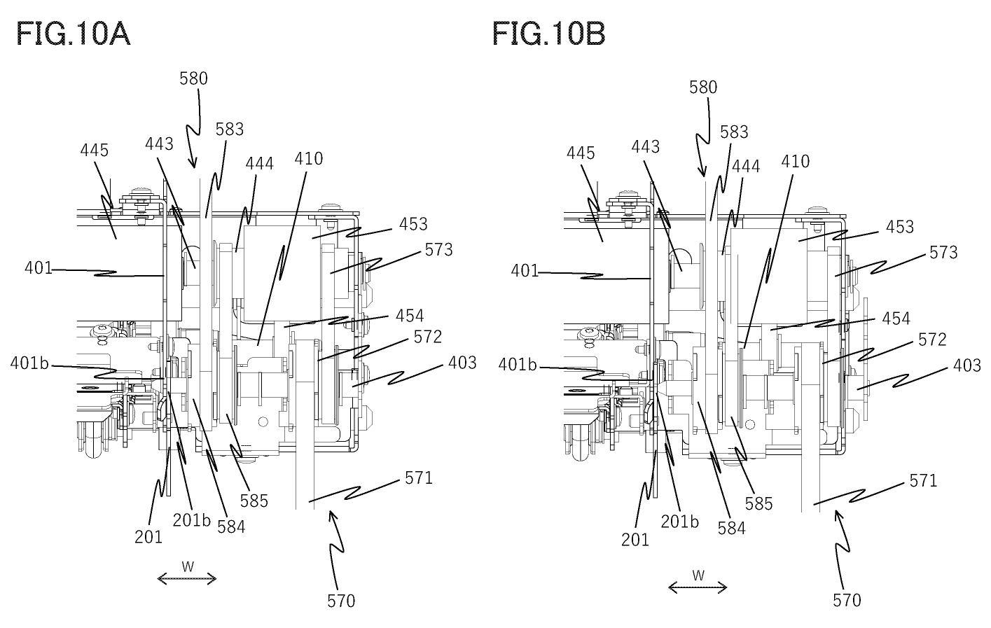

Next, a roller separation structure of the discharge driven roller 411 in the discharge unit 400 will be described using FIGS. 8-10B. FIG. 8 is a perspective view illustrating the separation drive structure of the discharge roller pair according to this embodiment. FIG. 9A is a perspective view illustrating the separation mechanism in a state in which the discharge roller pair according to this embodiment is brought into pressure contact. FIG. 9B is a perspective view illustrating the separation mechanism in a state in which the discharge roller pair according to this embodiment is separated. FIG. 10A is a side view illustrating a state in which the rear side pivot shaft according to this embodiment is mounted to the apparatus body frame and the conveyance support frame. FIG. 10B is a side view illustrating a state in which the rear side pivot shaft according to this embodiment is withdrawn from the apparatus body frame and the conveyance support frame.

The separation motor 258 is drive controlled by the control unit (not shown), and in a case where the shift roller unit 430 is moved by driving the shift motor 259 so as to move the sheet in the width direction W, the separation motor 258 brings the discharge drive and driven rollers 410 and 411 into pressure contact to nip the sheet. In addition, at least in a case where a position of the shift roller unit 430 in the width direction is returned to an initial position through the drive of the shift motor 259, the discharge drive and driven rollers 410 and 411 are separated from each other to release the sheet.

The separation motor 258 described above is fixedly supported by the apparatus body frame 201 (refer to FIG. 4). In addition, as illustrated in FIG. 8, the drive rotation which is output from the separation motor 258 is transmitted to the separation mechanism 440 (refer to FIGS. 9A and 9B) of the discharge unit 400 by the separation transmission portion 580. That is, it can be said that the separation motor 258 and the separation transmission portion 580 are not supported by the discharge unit 400, but are disposed outside the discharge unit 400. On the other hand, the separation mechanism 440 is supported by the discharge unit 400, and it can be said that the separation mechanism 440 is provided in the discharge unit 400.

The separation transmission unit 580 includes a belt 581 to which the drive rotation of the separation motor 258 is transmitted, and a pulley 582 that is rotated by the belt 581 through the drive rotation of the separation motor 258. In addition, the separation transmission portion 580 includes a belt 583, serving as a first belt, to which the rotation of the pulley 582 is transmitted. Further, the separation transmission portion 580 includes a pulley 584, serving as a first rotary member, to which the rotation of the pulley 582 is transmitted via the belt 583, and a belt 585, serving as a second belt, to which the rotation of the pulley 584 is transmitted. Among these components, the pulley 584 is rotatably supported with respect to the rear side pivot shaft 403 described above. Then, the belt 585 transmits rotation to a pulley 444 secured to a separation drive shaft 443 of the separation mechanism 440.

The separation mechanism 440 broadly includes a separation gear mechanism 450A disposed forward of the shift roller unit 430 in the width direction W, a separation gear mechanism 450B disposed rearward of the shift roller unit 430 in the width direction W, and the separation drive shaft 443. The separation drive shaft 443 is rotatably supported with respect to the shift roller unit 430, and, by disposing the pulley 444 as described above, the drive rotation of the separation motor 258 is transmitted via the separation transmission portion 580, that is, rotated by the separation motor 258. Then, the separation drive shaft 443 transmits the drive rotation of the separation motor 258 to the separation drive gears 445 respectively disposed in the separation gear mechanisms 450A and 450B.

Since the separation gear mechanisms 450A and 450B have substantially the same configuration, the separation gear mechanism 450A will be described, and the description of separation gear mechanism 450B will be omitted. As illustrated in FIG. 9B, the separation gear mechanism 450A includes the separation drive gear 445, serving as a second rotatory member, secured to the separation drive shaft 443. Further, the separation gear mechanism 450A includes a separation cam gear 446, serving as a separation cam, that meshes with the separation drive gear 445, and a follower 447 secured to a shaft of the discharge driven roller 411. That is, the separation cam gear 446 is provided with a gear shape and a cam shape, and the gear shape meshes with the separation drive gear 445 while the cam shape presses the follower 447.

When the separation drive shaft 443 is rotated by the separation motor 258, the separation drive gear 445 is rotated in the separation gear mechanism 450A, and the separation cam gear 446 is also rotated. When the separation cam gear 446 rotates by a predetermined amount, the cam shape of the separation cam gear 446 comes into contact with the follower 447. As a result, as illustrated in FIG. 9B, the discharge driven roller 411 is pressed via the follower 447 toward a side opposite to the discharge drive roller 410 while resisting an urging force exerted by an urging member (not shown); thereby, the discharge driven roller 411 is separated from the discharge drive roller 410. That is, the separation cam gear 446 comes into contact with the follower 447, and moves the shaft of the discharge driven roller 411; thereby, a distance between axes of the discharge drive and driven rollers 410 and 411 is changed. To be noted, as illustrated in FIG. 8, the separation drive gear 445 is formed to be wide in the width direction W, and is configured such that, even when the shift roller unit 430 moves in the width direction W, the drive can be transmitted to the separation cam gear 446.

To be noted, the pulleys 582, 584, and 444 of the separation transmission portion 580 described above each employ a common configuration for cost reduction purposes; however, it is not limited to this, and pulleys having different configurations from each other may be employed.

### When Mounting and Removing Discharge Unit in Separation Drive Structure

Here, a case where the discharge unit 400 is mounted to or removed from the apparatus body frame 201 in the separation drive structure will be described using FIGS. 10A and 10B.

As illustrated in FIGS. 10A and 10B, the rear side pivot shaft 403 is configured to move in the axial direction, which is the width direction W, while retaining the pulley 584. That is, as illustrated in FIG. 10B, by sliding the rear side pivot shaft 403 toward the rear side in the width direction W, the rear side pivot shaft 403 can be withdrawn from the through hole 401b of the support frame 401 and the through hole 201b of the apparatus body frame 201. To be noted, although not illustrated, similarly, by sliding the front side pivot shaft 402 toward the front side in the width direction W, the front side pivot shaft 402 can be withdrawn from the through hole 401a of the support frame 401 and the through hole 201a of the apparatus body frame 201 (refer to FIG. 4). Further, the screws 408 and 409 (refer to FIG. 5) securing the apparatus body frame 201 to the support frame 401 are removed. Thereby, the discharge unit 400 can be removed from the apparatus body frame 201, that is, becomes removable. To be noted, by performing the removal operation described above in reverse, the discharge unit 400 can be mounted to the apparatus body frame 201. With the configuration described above, while enabling a structure that transmits the drive rotation from the separation motor 258 disposed with respect to the apparatus body frame 201 to the separation mechanism 440 of the discharge unit 400, a configuration that enables easy removal of the discharge unit 400 from the apparatus body frame 201 can be achieved. Therefore, the replaceability of the discharge unit 400 can be improved.

### Conveyance Drive Structure of Discharge Drive Roller

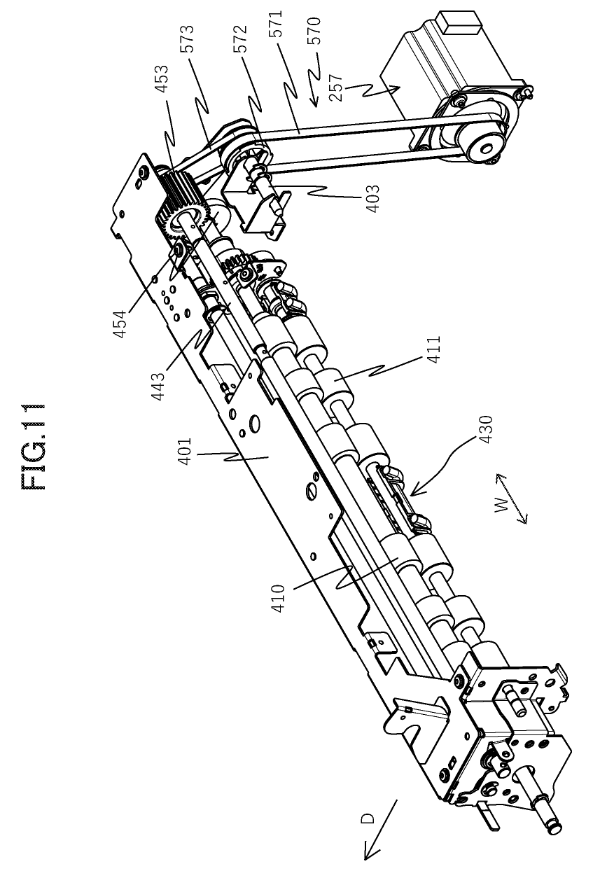

Next, a roller drive structure of the discharge drive roller 410 in the discharge unit 400 will be described using FIGS. 10A to 11. FIG. 11 is a perspective view illustrating the conveyance drive structure of the discharge roller pair according to this embodiment.

The conveyance motor 257 described above is fixedly supported by the apparatus body frame 201 (refer to FIG. 4). In addition, as illustrated in FIG. 11, the drive rotation of the conveyance motor 257 is transmitted to the discharge drive roller 410 of the discharge unit 400 by the conveyance transmission portion 570. That is, it can be said that the conveyance motor 257 and the conveyance transmission portion 570 are not supported by the discharge unit 400, but are disposed outside the discharge unit 400.

The conveyance transmission portion 570 includes a belt 571, serving as a third belt, to which the drive rotation of the conveyance motor 257 is transmitted, and a pulley 572, serving as a third rotary member, to which the drive rotation of the conveyance motor 257 is transmitted via the belt 571. In addition, the conveyance transmission portion 570 includes a belt 573, serving as a fourth belt, to which the rotation of the pulley 572 is transmitted. Among these components, the pulley 572 is rotatably supported with respect to the rear side pivot shaft 403 described above. In addition, the belt 573 is disposed in the discharge unit 400, and transmits rotation to a conveyance idler gear 453 rotatably supported by the separation drive shaft 443 described above. Then, the conveyance idler gear 453 is meshed with a drive gear 454 secured to the discharge drive roller 410, and transmits rotation to the drive gear 454. To be noted, the conveyance idler gear 453 is formed wide in the width direction W, and is configured such that, even when the shift roller unit 430 moves in the width direction W, the drive can be transmitted to the drive gear 454.

To be noted, the pulley 572 of the conveyance transmission portion 570 described above employs a pulley having a common shape with each of the pulleys 582, 584, and 444 in the separation transmission portion 580 described above for cost reduction purposes; however, it is not limited to this, and a pulley having a different shape may be employed.

### When Mounting and Removing Discharge Unit in Conveyance Drive Structure

Here, a case of mounting and removing the discharge unit 400 to and from the apparatus body frame 201 in the conveyance drive structure will be described using FIGS. 10A and 10B.

As illustrated in FIGS. 10A and 10B, the rear side pivot shaft 403 described above is configured to move in the axial direction, which is the width direction W, while retaining the pulley 572. Here, as described above, the rear side pivot shaft 403 is slid to the rear side in the width direction W (refer to FIG. 10B), the front side pivot shaft 402 is slid to the front side in the width direction W (refer to FIG. 4), and the screws 408 and 409 (refer to FIG. 5) are removed. Thereby, it becomes possible to remove the discharge unit 400 from the apparatus body frame 201, that is, becomes removable. With the configuration described above, a structure is enabled that transmits the drive rotation from the conveyance motor 257 disposed with respect to the apparatus body frame 201 to the discharge drive roller 410 of the discharge unit 400. In addition, this configuration simultaneously enables a structure that allows the discharge unit 400 to be readily removed from the apparatus body frame 201. Therefore, the replaceability of the discharge unit 400 can be enhanced.

### Summary of This Embodiment

As described above, in this embodiment, the discharge unit 400 including the discharge path 492 is pivotably supported with respect to the apparatus body frame 201. Thereby, the gradual connection between the discharge path 492 and the merging conveyance path 110 is enabled, and, even in a case of high rigidity sheets, it is possible to stably convey the sheet from the sheet feeding apparatus 2 to the image forming apparatus 1A.

In addition, in this embodiment, the discharge roller pair 244 of the discharge unit 400 is configured to move in the width direction W, and the lateral deviation registration correction is performed to correct the positional deviation of the sheet in the width direction based on the position of the side edge of the sheet detected by the first lateral registration sensor S3. That is, while feeding of various types of sheets is enabled particularly by feeding the sheet by the air suction method, positional deviations in the width direction W are likely to occur. Even when feeding of the sheet is performed by such an air suction method, by executing the lateral deviation registration correction, stable and accurate conveyance is enabled even for sheets having high rigidity.

Then, the shift roller unit 430 including the discharge roller pair 244, the shift motor 259, and the shift drive unit 420 that moves the shift roller unit 430 in the width direction W are supported by the support frame 401 of this discharge unit 400. Thereby, the sheet feeding apparatus 2 can be miniaturized as compared to, for example, a configuration in which a unit for discharging the sheet and a unit for shifting the width direction of the sheet are arranged in sequence in the sheet conveyance direction.

### Possibility of Other Embodiments

In this embodiment described above, the conveyance path 491, the discharge roller pair 244, the discharge path 492, the shift drive structure, the separation drive structure, and the conveyance drive structure are disposed so as to be collectively supported by the discharge unit 400. However, it is not limited to this, and even if only the discharge path 492, the discharge roller pair 244, and the shift drive structure are disposed in the discharge unit 400, there is an effect of miniaturizing the sheet feeding apparatus 2. Accordingly, the separation drive structure and the conveyance drive structure are not necessarily required to be provided in the discharge unit 400, and the configuration may be such that only one of these is provided in the discharge unit 400.

In addition, in this embodiment, the discharge roller pair 244 is moved by the movement of the shift roller unit 430, including the discharge roller pair 244, in the width direction W. However, it is not limited to this, and the discharge roller pair 244 may be directly moved in the width direction W. In this case, the conveyance unit is constituted by the discharge roller pair 244.

In addition, in this embodiment, only the separation mechanism 440 is supported by the support frame 401 of the discharge unit 400, and the separation motor 258 and the separation transmission portion 580 are supported by the apparatus body frame 201. However, it is not limited to this, and the separation transmission portion 580 may be supported by the support frame 401 of the discharge unit 400, or the separation motor 258 and the separation transmission portion 580 may be supported by the support frame 401 of the discharge unit 400.

In addition, in this embodiment, the conveyance motor 257 and the conveyance transmission portion 570 are supported by the apparatus body frame 201. However, it is not limited to this, and the conveyance transmission portion 570 may be supported by the support frame 401 of the discharge unit 400, or the conveyance motor 257 and the conveyance transmission portion 570 may be supported by the support frame 401 of the discharge unit 400.

In addition, in this embodiment, the image forming system 1 is constituted by the sheet feeding apparatus 2 and the image forming apparatus 1A; however, it is not limited to this. For example, a plurality of sheet feeding apparatuses may be connected in series in the sheet conveyance direction. In addition, one or more processing apparatuses that respectively perform stapling, punching, bookbinding, and inspection may be connected downstream of the image forming apparatus 1A in the sheet conveyance direction. In a case where a plurality of apparatuses are thus connected, an apparatus disposed downstream of a sheet conveyance apparatus that includes a pivotable discharge unit as in this embodiment constitutes a downstream apparatus that receives the sheet discharged from the discharge path.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078139, filed May 8, 2025, which is hereby incorporated by reference herein in its entirety.

What is claimed is:

1. A sheet conveyance apparatus comprising:
an apparatus body frame;
a conveyance unit configured to convey a sheet;
a movement mechanism configured to move the conveyance unit in a width direction orthogonal to a sheet conveyance direction;
a movement drive unit configured to drive the movement mechanism;
a guide portion configured to guide the sheet conveyed by the conveyance unit toward an outside of the sheet conveyance apparatus; and
a support frame configured to support the conveyance unit, the movement mechanism, the movement drive unit, and the guide portion,
wherein the support frame is configured to be pivotably supported with respect to the apparatus body frame.

2. The sheet conveyance apparatus according to claim 1,
wherein the conveyance unit includes a drive roller, a driven roller rotatably driven by the drive roller, and a conveyance frame configured to rotatably support the drive roller and the driven roller, and
wherein the movement mechanism is configured to move the conveyance frame in the width direction by drive rotation of the movement drive unit.

3. The sheet conveyance apparatus according to claim 1,
further comprising a support shaft configured to pivotably support the support frame with respect to the apparatus body frame.

4. The sheet conveyance apparatus according to claim 3,
wherein the conveyance unit includes a drive roller, a driven roller rotatably driven by the drive roller, and a separation mechanism configured to separate the drive roller and the driven roller,
wherein the sheet conveyance apparatus further comprising:
a separation drive unit configured to output drive rotation for driving the separation mechanism; and
a separation transmission portion configured to transmit the drive rotation of the separation drive unit to the separation mechanism, and
wherein the separation transmission portion includes a first rotary member disposed rotatably around the support shaft as a center, and configured to receive transmission of the drive rotation of the separation drive unit and to transmit the drive rotation to the separation mechanism.

5. The sheet conveyance apparatus according to claim 4,
wherein the separation transmission portion includes a first belt and a second belt,
wherein the first belt is configured to rotate the first rotary member by transmitting the drive rotation of the separation drive unit to the first rotary member, and
wherein the second belt is configured to transmit rotation of the first rotary member to the separation mechanism.

6. The sheet conveyance apparatus according to claim 5,
wherein the separation mechanism includes a separation cam that, by being rotated, is configured to change an axis distance between the drive roller and the driven roller, and a second rotary member that is configured to rotate the separation cam by being rotated by the second belt.

7. The sheet conveyance apparatus according to claim 4,
wherein the support shaft, which is in a state of supporting the first rotary member, is configured to be withdraw from at least one of the support frame and the apparatus body frame in an axial direction so that the conveyance unit can be removed from the apparatus body frame.

8. The sheet conveyance apparatus according to claim 4,
wherein, in a case of moving the conveyance unit to move the sheet in the width direction by driving the movement drive unit, the separation drive unit is configured to nip the sheet by bringing the drive roller and the driven roller into pressure contact, and, in a case of returning a position in the width direction of the conveyance unit to an initial position by driving the movement drive unit, the separation drive unit is configured to release the sheet by separating the drive roller and the driven roller.

9. The sheet conveyance apparatus according to claim 3,
wherein the conveyance unit includes a drive roller, and a driven roller rotatably driven by the drive roller,
wherein the sheet conveyance apparatus further comprising:
a conveyance drive unit configured to output drive rotation for driving the drive roller; and
a conveyance transmission portion configured to transmit the drive rotation of the conveyance drive unit to the drive roller, and
wherein the conveyance transmission portion includes a third rotary member disposed rotatably around the support shaft as a center, and configured to receive transmission of the drive rotation of the conveyance drive unit and to transmit the drive rotation to the drive roller.

10. The sheet conveyance apparatus according to claim 9,
wherein the conveyance transmission portion includes a third belt and a fourth belt,
wherein the third belt is configured to rotate the third rotary member by transmitting the drive rotation of the conveyance drive unit to the third rotary member, and
wherein the fourth belt is configured to transmit rotation of the third rotary member to the drive roller.

11. The sheet conveyance apparatus according to claim 9,
wherein, the support shaft, which is in a state of supporting the third rotary member, is configured to be withdrawn from at least one of the support frame and the apparatus body frame in an axial direction so that the conveyance unit can be removed from the apparatus body frame.

12. The sheet conveyance apparatus according to claim 9,
further comprising a first detection unit disposed upstream of the conveyance unit in a sheet conveyance direction, the first detection unit being configured to detect a leading edge of the sheet that has been conveyed.

13. The sheet conveyance apparatus according to claim 12,
wherein, based on a detection result of the first detection unit, the conveyance drive unit is configured to stop the drive roller such that the sheet is brought into abutment with a nip formed by the drive roller and the driven roller and is deflected, and, thereafter, the conveyance drive unit is configured to drive the drive roller for correcting skew of the sheet.

14. The sheet conveyance apparatus according to claim 1,
further comprising a second detection unit disposed upstream of the conveyance unit in the sheet conveyance direction, the second detection unit being configured to detect a position in the width direction of the sheet that has been conveyed.

15. The sheet conveyance apparatus according to claim 14,
wherein the second detection unit is an image reading sensor configured to perform image detection of the sheet, and
wherein the sheet conveyance apparatus further comprises an opposing guide that is disposed opposite to the image reading sensor and is configured to form a conveyance path for the sheet.

16. The sheet conveyance apparatus according to claim 14,
wherein the movement drive unit is configured to correct the position in the width direction of the sheet by being driven and moving the sheet in the width direction based on a detection result of the second detection unit.

17. The sheet conveyance apparatus according to claim 1,
further comprising a sheet feeding unit configured to feed the sheet toward the conveyance unit.

18. The sheet conveyance apparatus according to claim 17,
wherein the sheet feeding unit is configured to feed the sheet by drawing air to attract the sheet.

19. A sheet conveyance system comprising:
the sheet conveyance apparatus according to claim 1; and
a downstream apparatus that is connected to the sheet conveyance apparatus on a downstream side in the sheet conveyance direction and is configured to receive the sheet discharged from the guide portion.

20. An image forming system comprising:
the sheet conveyance apparatus according to claim 1; and
an image forming apparatus including an image forming unit that is configured to form an image on the sheet, the image forming apparatus being connected to the sheet conveyance apparatus on a downstream side in the sheet conveyance direction, the image forming apparatus being configured to form the image on the sheet by receiving the sheet discharged from the guide portion.
